(19) United States
(12) Patent Application Publication
(10) Pub. No.: US 2003/0028353 A1
(43) Pub. Date: Feb. 6, 2003

(54) Production pattern-recognition artificial neural net (ANN) with event-response expert system (ES)--yieldshieldTM

(76) Inventor: Brian Gventer, Fort Worth, TX (US)

Correspondence Address: STEVEN A. SHAW, NOKIA, INC., 6000 CONNECTION DRIVE, MD 1-4-755, IRVING, TX, 75039, US

(21) Appl. No.: 09/923,215

(22) Filed: Aug. 6, 2001

(51) Int. Cl. G06F 11/30; G06F 15/00; G21C 17/00

(52) U.S. Cl. 702/182

(57) ABSTRACT

Artificial Neural Net (ANN) coupled with an Expert System (ES) which monitors production test plans in real-time is provided. The ANN recognizes and classifies production yield patterns occurring at individual tester, complete test stage, and production line test aggregation and executes a proscribed range of responses. The ANN will automate human statistical analysis and line monitoring functions, identify emerging yield trends, identify proximate cause of a yield-degrading event, classify event severity, and provide conclusional accuracy. The ES, based on recognized or inferred conditions provided by the ANN, consults it's knowledge base and applies cognitive heuristics to execute responses in the manner described by the human expert it is modeled after. These responses may include a summary report electronically to the correct individuals, a voice/pager message to the individuals responsible to react to an event, a visual or audible alarm at the event site, and/or direct adjustment of the production process

### BACKGROUND OF THE INVENTION

The present invention relates generally to testing of electronic devices. More particularly, the present invention relates to a cellular Radio Frequency (RF) mobile station production/testing and statistical monitoring process using an Artificial Neural Network (ANN).

Prior art production methodology relied on centralized testers doing long arduous test plans and catching process problems long after they occurred. The testers were then considered suspect until proven innocent at which point the actual proximate cause could be investigated and corrected. Often after significant numbers of unsound and unreliable product were built, and subsequently a massive rework effort ensued. This results in wasted product, money, and resources.

An experienced human monitoring the process with undivided attention is still unable to effectively monitor and identify a yield threatening trend. The intricacy and range of data managed by a single tester in production is currently difficult for less than experienced engineers. The ability for many individuals to further understand and correlate the measurement values and hidden inter-relationships is exponentially complex when stages of 10 testers are aggregated, compounded yet again by correlating inter-relationships between test stages.

A classic example of the problem is power level two upperband tuning failures across eight testers in Final/UI (Final Assembly Test Stage) of mobile stations. In this example, the failure is induced by a particular tester at Flash SWA (SMD Test Stage) incorrectly tuning power levels due to faulty calibration. Currently, a sharp engineer standing there and concentrating as the event unfolds, may realize that the failures are all from a single source. Typically on a fully alert day shift, this realization occurs after hundreds of phones are incorrectly built, and yields are severely degraded. In a night shift weekend scenario a problem may last until Monday morning.

Deep understanding of the vast amount of data is done through exhaustive SPC statistical analysis. The linear regression techniques usually require very thorough calculations by a black-belt level statistician seeking specific information and rarely turns up unknown or hidden inter-related data points or inter-dependancies. The deep data mining by humans ordinarily is days or weeks after an event.

One possible solution is the use of automatically controlled machinery (ACM) which are playing an increasingly important role in our industry, our economy and our society. (ACM) can be used to replace human labor in tasks that are dull and repetitive or they can be used to perform tasks requiring extreme precision, speed or strength which is beyond human capabilities.

A technology that has developed hand-in-hand with robotics and automatic control is artificial intelligence. Artificial Intelligence technology (AI) refers to the use of digital circuits to mimic the cognitive and symbolic skills of humans. When the principles of artificial intelligent are applied to automated machinery their usefulness is increased to an even greater degree. AI allows automatic machines to be programmed to perform complex tasks, to react to external inputs and even to perform rudimentary decision making. Artificial intelligence (AI) systems can integrate data accumulation, recognition and storage functions with higher order analysis and decision protocols. AI systems such as expert systems and neural networks find wide application in qualitative analysis. Expert systems typically generate an individual data structure which is analyzed according to a knowledge base working in conjunction with a resident database.

Neural networks are a type of data processing system whose architecture is inspired by the structure of the neural systems of living beings. Unlike the serial connections of the digital computers used for AI systems, neural networks are highly interconnected with variable weights assigned to each of the interconnections. Their architecture allows neural networks to actually learn and to generalize from their knowledge. Therefore, neural networks are taught or trained rather than programmed. Some neural networks are even capable of independent or autonomous learning, or learning by trial and error.

The ability of neural networks to learn and to generalize from their knowledge makes them highly useful as automated controllers for robots also known as neural network controllers. Neural network controllers controlling for example a robot, may be taught by taking it through a series of training sets, which present data typical of what the robot will see in operation. From these training sets, the robot can “generalize” to react properly to new situations encountered in actual operation, even if they do not exactly match the training sets from which they were taught. Some neural networks may be self-organizing (or un-supervised), that is., they learn from these new situations and add it to the data learned from their training sets by adjusting the weights assigned to the interconnections between their processing elements. Two types of neural networks capable of self organizing are back-propagation networks and adaptive resonance networks.

The roots of the work on neural networks can be found in a 1943 paper by W. S. McCulloch and W. H. Pitts, “A logical calculus of ideas immanent in nervous activity,” Bulletin of Mathematical Biophysics, 4, 115 (1943). McCulloch and Pitts modeled the brain as a collection of neurons with one of two states, sᵢ=0 (not firing) or sⱼ=1 (firing at maximum rate). If there is a connection from neuron i to neuron j, the strength or weight of this connection is defined as wᵢⱼ. Each neuron adjusts its state asynchronously according to the threshold rule:

$${s}_{i} = [ \begin{matrix}1 \\ 0\end{matrix} ] \text{if} {\sum }_{j} {w}_{ij} {s}_{j} [ \begin{matrix}< \\ >\end{matrix} ] {θ}_{i}$$

where θᵢ is the threshold for neuron i to fire.

Another seminal idea in neural or brain models also published in the 1940s was Hebb's proposal for neural learning, D. O. Hebb, “The Organization of Behavior” Wiley, N.Y. (1949). Hebb states that if one neuron repeatedly fires another, some change takes place in the connecting synapse to increase the efficiency of such firing, that is, the synaptic strength or weight is increased.

FIG. 1 is illustrative of a simple artificial neural network (ANN). Signals X₁ to Xₙ are inputs of an artificial neuron and Y is an output signal. The values of the input signals X₁ to Xₙ may be constantly changing (analogous) or binary quantities, and the output signal Y may usually be given both positive and negative values. W₁ to Wₙ are weighting coefficients, i.e. synaptic strengths or weights, which may also be either positive or negative. In some cases, only positive signal values and/or weighting coefficients are used. Synapses 11₁ to 11ₙ of the neuron weight the corresponding input signal by weighting coefficients W₁ to Wₙ. A summing circuit 12 calculates a weighted sum U. The sum U is supplied to a thresholding function circuit 13, whose output signal is V. The threshold function may vary, but usually a sigmoid or a piecewise linear function is used, whereby the output signal is given continuous values. In a conventional neuron, the output signal V of the thresholding function circuit 13 is simultaneously the output signal Y of the whole neuron.

When neurons of this kind are used in ANNs, the network is trained, i.e. suitable values are found for the weighting coefficients W₁ to Wₙ. Different algorithms have been developed for the purpose. A neural network that is capable of storing repeatedly supplied information by combining different signals, for example, a certain input and a certain situation is called an associative neural network. In associative neurons, different versions of what is known as the Hebb rule are often used. According to the Hebb rule, the weighting coefficient is increased always when the input corresponding to the weighting coefficient is active and the output of the neuron should be active. The changing of the weighting coefficients according to the algorithms is called the training of the neural network.

While reference will be made to specific types of neural networks in the specification, it is not the intention of this specification to teach the design or architecture of neural networks, but to advance the application of neural network technology to automatic control technology. It should also be understood by the reader that the specific types of neural networks referred to are given by way of example and that other types of neural networks may also be used with the disclosed control method. A background in ANN may be found in “Artificial Neural Networks” by Robert J. Schalkoff, published by McGraw-Hill Companies ISBN 0-07-057118-X herein incorporated by reference (http://www.mhcollege.com).

An example of in the patent art which provides a background in ANN for the reader is U.S. Pat. No. 5,214,745 issued to John Sutherland on May 25, 1993 and is herein incorporated by reference.

U.S. Pat. No. 5,355,435 issued to DeYong et al. provides the reader with the design considerations of a neural processing element (PE) and is herein incorporated by reference. DeYong et al. considers the implementation methodologies used in Very Large Scale Integration (VLSI) neural networks. DeYong et al. considers implementation details such as analog vs. digital, biological vs. non-biological, time-dependent vs. time-independent, continous/asynchronous vs. discrete/synchronous, triggerable vs. non-triggerable, and linear vs. non-linear.

Since neurons work on a spike or pulse based triggers a spike-based implementation for analog-to-digital conversion is very well suited to ANN circuit designs. An example of an analog-to-digital converter is provided by U.S. Pat. No. 6,262,678 issued to Rahul Sarpeshkar on Jul. 17, 2001.

An example of neural networks which have been used in optical character recognition applications is given by U.S. Pat. No. 5,251,268 issued to Colley et al. on Oct. 5, 1993 and incorporated herein by reference.

Prior to the present invention, production and testing is monitored by an experienced human. A human supervising the process with undivided attention is still unable to effectively monitor and identify a yield-threatening trend. The intricacy and range of data managed by a single tester in production is currently difficult for less than experienced engineers. The ability for many individuals to further understand and correlate the measurement values and hidden inter-relationships is exponentially complex when stages of 10 testers are aggregated, compounded yet again by correlating inter-relationships between test stages.

Earlier production methodology relied on centralized testers doing long arduous test plans, and catching process problems long after they occurred. The testers were then considered suspect until proven innocent at which point the actual proximate cause could be investigated and corrected. Often after significant numbers of unsound and unreliable product was built, and subsequently a massive rework effort ensued. Testers are often relied upon to “test” quality into the system. There is a need to verify processes at the point of operation, and identify problems early.

Prior to the present invention, monitoring consists of technicians and supervisors standing in front of a monitor flipping through displays. If experienced, they can identify trends as they became statistically significant. Often that effort is investigative, only drawing attention after the problem becomes significant. Even experienced monitors may have problems monitoring multiple testers with their exponentially increasing complexity as stated above. Other methods for monitoring included exhaustive Statistical Process Control (SPC) tools which required highly trained and competent engineers targeting specific points of data not close to real-time.

It is in light of this background information related to the production and testing of mobile stations that the significant improvement of the present invention has evolved.

### SUMMARY OF THE INVENTION

Embodiments of the present invention, accordingly, advantageously provide a production/testing and statistical monitoring process.

Artificial Neural Net (ANN) coupled with an Expert System (ES) which monitors production test plans in real-time is provided. The ANN recognizes and classifies production yield patterns occurring at individual tester, complete test stage, and production line test aggregation and executes a proscribed range of responses. The ANN will automate human statistical analysis and line monitoring functions, identify emerging yield trends, identify proximate cause of a yield-degrading event, classify event severity, and provide conclusional accuracy. The ES, based on recognized or inferred conditions provided by the ANN, consults it's knowledge base and applies cognitive heuristics to execute responses in the manner described by the human expert it is modeled after. These responses may include a summary report electronically to the correct individuals, a voice/pager message to the individuals responsible to react to an event, a visual or audible alarm at the event site, and/or direct adjustment of the production process.

A more complete appreciation of the present invention and the scope thereof can be obtained from the accompanying drawing which are briefly summarized below, the following detailed description of the presently-preferred embodiment of the invention, and the appended claims.

### BRIEF DESCRIPTION OF THE DRAWINGS

FIG. 1 is illustrative of a simple artificial neural network.

FIG. 2 is illustrative of an optical inspection system.

FIG. 3 is an illustration of the production test flow using ANN to monitor test plan results in real-time.

FIG. 4 is a first time pass report that shows 10 testers on an tester line testing an user interface.

FIG. 5 is a list showing failures versus ATEs.

FIG. 6 is a bar graph showing production data.

### DETAILED DESCRIPTION

A novel apparatus and method for the production and testing of an electronic device is provided. The invention verifies processes at the point of operation and identifies problems early to save production yield, time, and other resources.

Assembly and installation process verification for a Device Under Test (DUT) may be monitored at the various points of assembly by vision systems which confirm/deny presence and placement of components. Failures due to process instability may fixed onsite along with the affected process. Failures due to imperfect materials/components may routed to quality control.

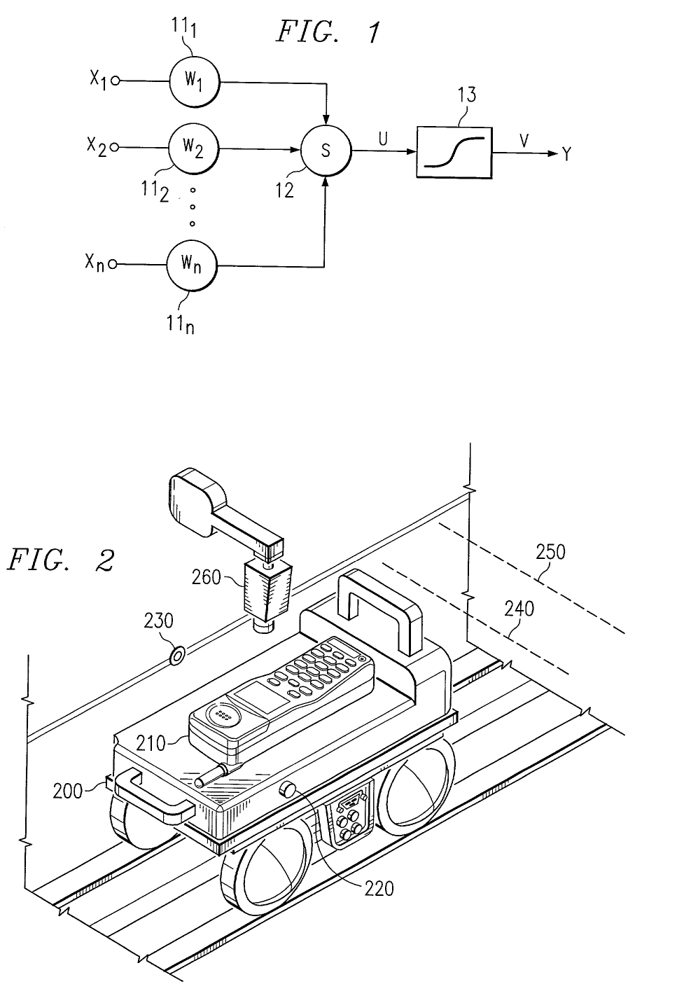

A visual inspection input into the ANN system may include an optical inspection system FIG. 2. FIG. 2 is an example of the preferred embodiment of the invention used in the environment of a DUT as described. FIG. 2 is an example only. Optical inspection system comprises an optical image capture device 260, IR fiducial sensor 230, IR fiducial emitter 220. Optical image capture device 260 may be camera, Charge Coupled Device (CCD) or the like. Optical image capture device 2600 may be moveable to allow for inspection control. Optical image capture device 260 may also be fixed and images DUT as it travels below said optical image capture device 610. The optical image capture device is activated when DUT on fixture passes pass a trigger line 240. There may also be ready line 250 wherein DUT and fixture pauses until the inspection area is ready to receive a new electronic device which is to be tested.

The CCD sensor collects samples representing successive video images. These samples are digitalized and transmitted to an artificial network for processing. U.S. Pat. No. 5,376,963 issued to Anthony Zortea describes a neural network video processor.

Certain aspects of RF/Baseband tuning, alignment, and measuring still require an unbroken calibrated galvanic connection with the DUT. These actions will occur concentrated in an RF shielded cell where a robotic arm/socket assembly will interface the moving fixture/fixture adapter, move with it for the duration of measurements, and extract when complete.

Once all standards are met, the DUT is certified a functionally sound and reliable RF handset, issued an electronic serial number (ESN) and powers down, all physical interfaces to the fixture adapter disengage. The handset routes to an off-loading and packaging cell where it is extracted from the fixture adapter, laser “branded”, packaged and shipped.

Artificial Intelligence decision support systems monitor yields and production trends. This automates the monitoring process at near real-time. For example, updates may occur once every 5 minutes.

Yield and process statistics are monitored near real-time by an Artificial Intelligence (AI) package, which incorporates the associative knowledge of Artificial Neural Nets (ANN) with the cognitive rule-based behavior of an Expert System (ES). The AI identifies patterns or trends and reacts according to established rule-sets governing process situations. Reactions range from notification of human authorities to alarms and even process alteration.

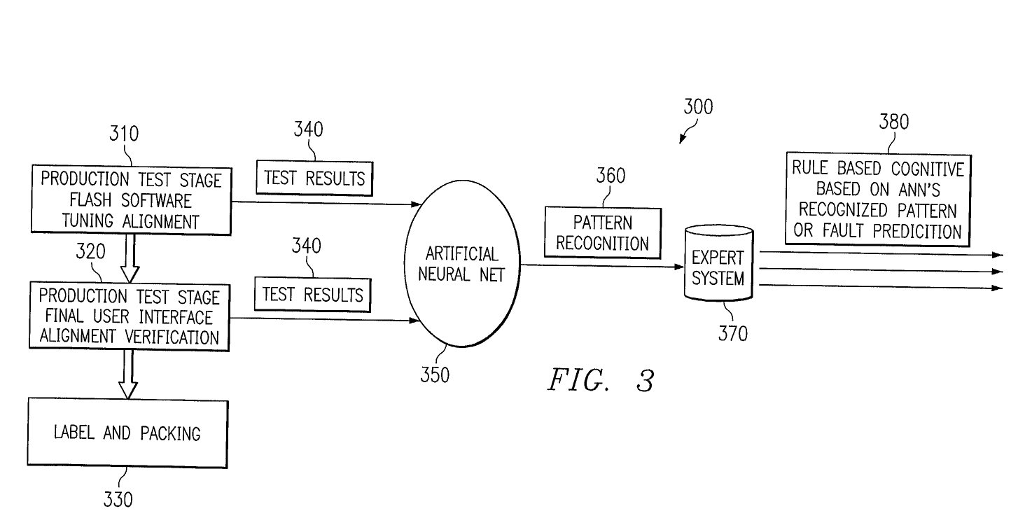

FIG. 3 is an illustration of the production test flow using Artificial Neural Net (ANN) 350 to monitor test plan results in real-time. ANN 350 measures individual stage trends during various stages 310 and 320. At stage 310, flash software test and tuning alignment in completed. At stage 320 final user interface test and alignment verification is performed. The ANN weighs trends 340 at each stage and correlations between said stages. The training of the ANN has established a specific threshold. ANN detects a pattern 360 when conclusional accuracy is above this specified threshold. Expert system 370 consults knowledge base for rules 380 governing response to ANN recognized pattern and executes applicable responses. The rules are example of cognitive heuristics which may be based on programming of knowledge base from human expert or may be extracted from case-based experiences programmed into the system or experienced by the ANN/ES system.

Artificial Neural Network (ANN) may identify and classify the same trend, recognize the pattern at preferably 3-5 failures, (approx. 24 mobile stations), hand off to the ES which pages a technician, provides event statistics to support the conclusion, and takes the suspect tester off-line. The ANN can also recognize that a seemingly unrelated test value is erratic or different from values in passing DUTs, thereby interpolating an inter-dependancy or trend indicator previously unrecognized. Thus, rework is reduced drastically and more consistent monitoring is achieved.

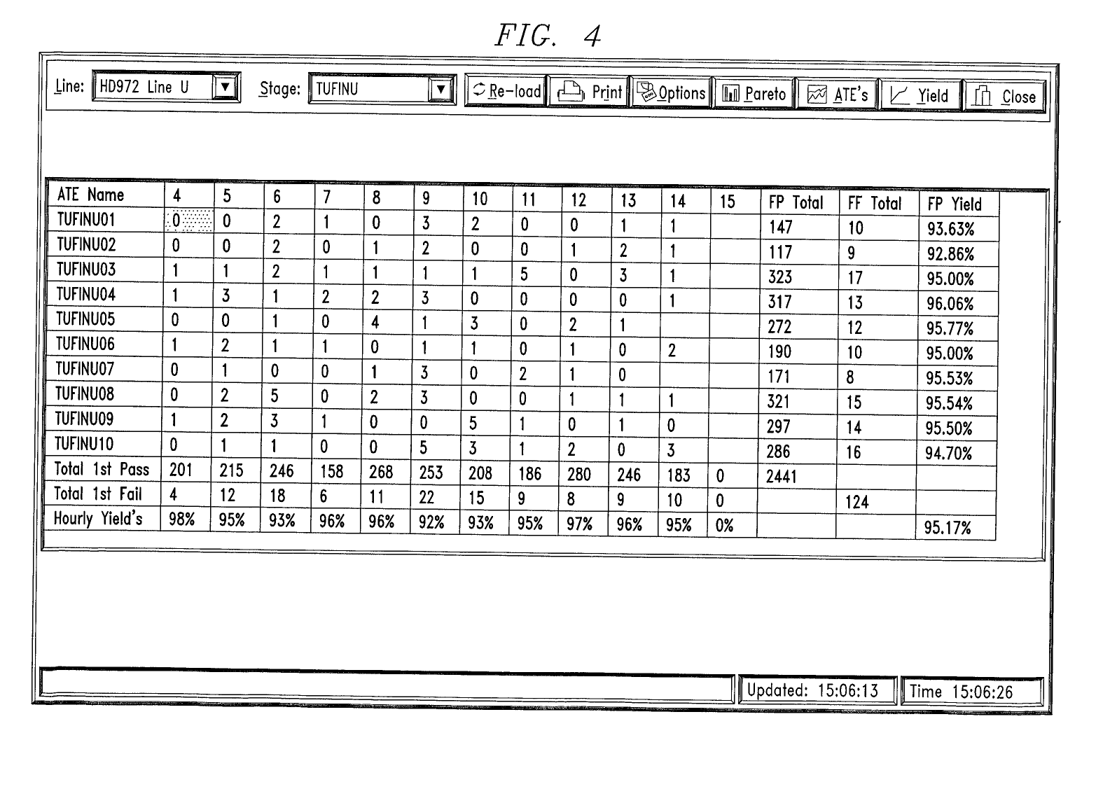

FIGS. 4, 5 and 6 show real-time tools available on the production floor at the time of the creation of the present invention. A human has to discern patterns from data, and then, once recognizing a pattern either know the correct response and enact it, or be able to find the right agents who can enact a solution. The ANN is able to provide for the pattern recognition without a human.

Expert system 370 is response to the pattern recognition 360 function in accordance with the present invention provides the event response. For any known case or failure mode there are proscribed actions that would be taken if everyone involved recognized they were required to do something. As an example, an human expert may be notified will shut down an erratic machine, send a page to the technician and line supervisor, and generate a report to all concerned.

For example, FIG. 4 is a first time pass report that shows 10 testers on an tester line testing an user interface. The line used in this example produces a mature DCT3 product. You can see based on the testers FP (first time pass) yield percentage that they range from 92.86% on tester 2 to 96.06% on tester 4, respectively.

At this point in the example, a human must try to discern what is the variance between all the different testers and why one is nearly 4% less productive (goal across NMP is 97% at this stage). Time ranges (across the top) from 0400 to 1500 with no production after 1400. This means that the line has for some reason stopped for over an hour in the example.

Total fails are shown by hour for each tester from left to right and total FP (first time pass) and FF (first time failure) by tester in column to the right of this shot. Tester number two has only produced 117 phones with 9 failures over this time span, while tester number 4 has produced 317 phones with 13 failures. Overall, tester number 2 has performed poorly for the entire period and is clearly a point of weakness, but clearly the whole stage is substandard and there are surely many issues.

At this point, human experience, skill, intuition, judgment, luck all come into play. There are easily hundreds of variables and indicators for thousands of possible problem combinations. As an example, there are about 110 test steps in this test plan. Some are simple yes or no tests and some are value ranges. False failures may occur in a single tester due to the tester itself, calibration between the fixture and the ATE rack, some failure in a particular instrument in the ATE rack. False failures can occur across the board due to equipment incompatibility, test plan code errors, calibration errors, network communications etc. There are also true failures indicating a process error (which is of course, the point, to testing).

A human must frequently study the monitor, try to discern patterns after they have begun to emerge, and correctly respond—a skill which varies widely from person to person, and from different hours of the day. An inexperienced person at 0230 on Saturday morning may miss a problem, and that problem may remain untreated until 0600 on Monday morning after thousands of aberrant handsets have been manufactured.

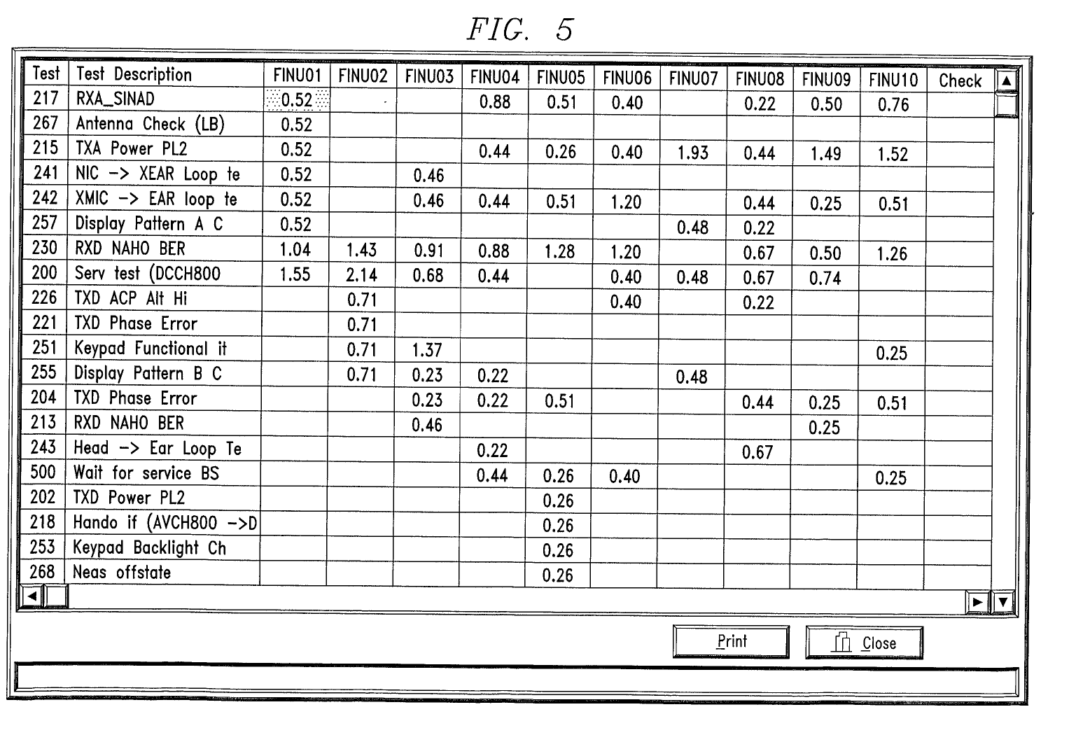

FIG. 5 is a list showing failures versus ATEs, tester failure percentages by test step ID in column. One may see test step ID failure percentages by tester in row. Note Test Step ID 230 (RXD MAHO BER—mobile assisted hand-off/bit error rate) has a consistent across the board (left to right) failure rate and percentages are consistent with quantities produced. EXCEPT tester number 7, a relatively average (for this sample) performing tester, has zero % failures. Is this tester allowing bad phones to actually pass?—Assume this case is a tester that is missing failures; an Expert System might page the test technician, and send a report of all phones passed over a given time frame so that samples may be gathered and retested. It also might pause the tester until it is verified.

Alternately, tester number 2 is the only one that has failed any phones for Test Step ID 221 (TXD Phase Error). More than likely this is a true failure given its low percentage, and also low actual number—1 out of 117. An expert might simply note this number and add it to an overall shift report. Unless the data correlations show the ANN that this is related to some other failure mode, it would simply continue to monitor.

Also, notice Test Step ID number 215—TXA Power Level 2 nearly across the board but low level.

Is this a calibration issue, a tuning error from a previous test stage (Flash and Software Alignment where the transmitter and receiver are tuned) or a component issue? If a component issue is it due to oven profiles, solder or underfill, errors, part placement, or just a bad lot of components? This would prompt an expert to request ANN correlation between those phones which failed and the testers from which they came. At the same time, a query of oven profiles and component reel changeovers would be examined to see if a likely SMD error occurred. If all the phones failing were from flash across the board, the expert would then direct calibration of all testers at Flash. If the bad phones come from a specific tester it would be shut down until verified. If it were instead found that an oven profile was erratic, that system could be corrected before hundreds of other failures might be induced. Again sending notifications and reports to all humans who need them.

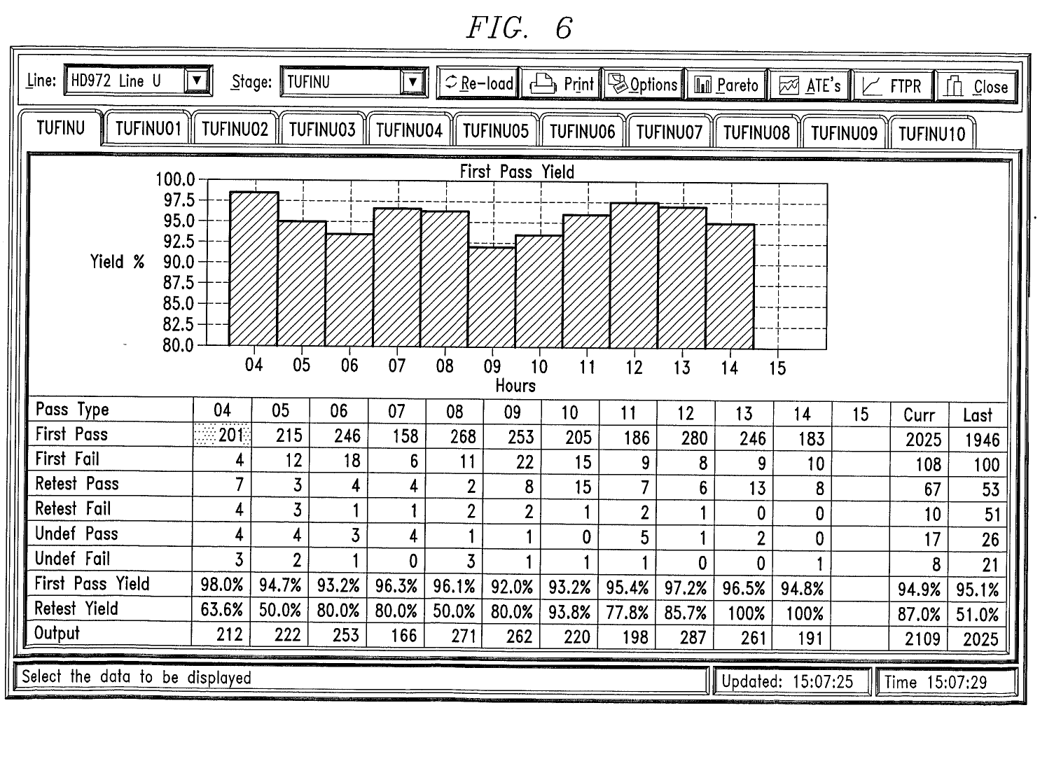

FIG. 6 is a bar graph which appears to the untrained as an indicator of good production because green means good. Actually it can be set to turn red on any threshold, and were this stage set to the stated 97% yield only 0400 and 1200 would be green.

Case-Based Reasoning Methods

Case-based reasoning methods and systems involve storing knowledge as a repository of successful cases of solved problems called a case base. When the system is presented with a problem, it searches the case base for similar cases. Once the similar cases are retrieved, various problem-solving strategies may be adapted to the case at hand. If the adapted strategy successfully solves the problem, then the newly solved problem may be added to the case base with the adapted solution.

The following is an example of a case based solution. A router profile may be incorrectly set causing the router to separate PCB radio modules out of the PCB panel. Specifically, the router may be cutting just microns too close to the antenna ground plane. The problem manifested itself at Final User Interface as a percentage of SINAD failures, and another percentage of antenna check failures, certain testers preferring to fail for SINAD, others for Antenna check. What appears as two separate problems may actually be the same problem. Technical and supervisory personhours may be spent scrutinizing the antenna assembly process to no avail, while simultaneously trying to find a power line noise factor cause for the SINAD failures, before someone notices on retest that certain phones always failed for antenna check on certain testers, and always failed for SINAD on certain others, and that the failures were actually related. The failure condition may be recognized differently on some radio test sets than others (due to inherent differences in instruments—newer test sets are able to handle the antenna weakness), though all may recognize the failure as either one thing or the other, and always the same thing. At this point, basic knowledge of the phone may be used to find how SINAD and antenna check are related. Upon visual inspection, it may be observed that the routing was cutting into the antenna ground plane. If an ANN is used to report the correlation, and the Expert System directs retests from diagnostics to go from one failure-type ATE to the other as a confirmation, hours of troubleshooting and hundreds of scrap phones can be saved. Also, because this may be assumed to be two discrete simple problems, only low-level production supervisors and technicians may be involved until the latter stages of trouble-shooting. Thus resulting in wasted production or down-time. An Expert might have sent notification to engineering staff that a serious complex problem existed, of a nature technicians simply were not experienced enough to solve.

In another example of a case-based problem from which an ANN may extract Expert System rules, a specific tester at Final User Interface may be failing display pattern tests—perhaps 10% of the time. Easily recognized by an ANN since none of the other testers are failing, it reports the pattern to the Expert System. Because the late-night staff is inexperienced, the simple but confusing vision calibration method escapes the technician. Often in the past these low-level problems are “walked-away from” hoping someone else will come along and fix it later. In the meantime 3-5 phones an hour are steadily failing, to be retested and passed in another tester after the diagnostic technician finds no fault. The Expert System would not only stop the tester, but also identify the procedure for vision calibration, the equipment required, and the directory of the necessary files. It would even be capable of walking the technician through the procedure step by step if so required, replacing the need for manuals, intensive training, years of experience and human experts.

In minutes the vision is “re-taught” and the tester back online.

A disadvantage is even self-learning ANN models will need periodic review/updates to ensure optimum accuracy. Expert Systems are only as accurate as the knowledge base and need periodic updating as well. Expert systems are dependent upon the ability of a knowledge engineer to extract accurate, precise heuristics from a bona-fide human expert or past case-based solutions.

Abbreviations

AI—Artificial Intelligence.

ATE—Automated Test Equipment. A chassis populated with instruments, controlled by a computer, which controls various measurements and tests on a DUT, and records results.

ANN—Artificial Neural Network: a computer model composed of a large number of interconnected, interacting, processing elements organized into layers. Mimics behavior of human nervous system at the neuronic level. ANN reasoning is associative in nature.

DUT—Device Under Test: May be any electrical device which is undergoing production and/or testing. In the preferred embodiment, the production of a PCB, radio module, or mobile station depending on the point of assembly.

ES—Expert System: A problem solving and decision making system based on knowledge of its task and logical rules and procedures for using the knowledge. Knowledge and logic are codified from the experience of human specialists in the field or from solutions of problems which have occurred in the past. ES reasoning is cognitive and rule-based in nature.

ESN—Electronic Serial Number.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention, for which reference should be made to the appended claims.

What is claimed is:

1. A system for monitoring a manufacturing production line, said system comprising:
an artificial neural network (ANN) for recognizing and classifying production yield patterns; and
an expert system (ES) coupled to said artificial neural network to provide a knowledge base and apply cognitive heuristics to execute responses based on production yield patterns information received from said artificial neural network.

2. The system of claim 1 wherein said ANN identifies a plurality of yield trends and assigns a weight to at least one of said production yield trends; and wherein said ANN outputs notification for identifying each of said at least one weighted production yield trend having an assigned weight beyond a predetermined yield-degrading threshold value.

3. The system of claim 1, further comprising instructions for training said ANN to assign said weight to each of said production yield trends based on historical case studies.

4. The system of claim 1, further comprising instructions for training said ANN to assign said weight to each of said production yield trends based on a base of knowledge.

5. The system of claim 1, further comprising instructions to send a report to predetermined individuals.

6. The system of claim 1, further comprising instructions to provide an alarm signal.

7. The system of claim 1, further comprising instructions to send a pager message to predetermined individuals.

8. The system of claim 1, further comprising instructions to adjust the production process in accordance with the knowledge base of the system.

9. A method for system for monitoring a manufacturing production line using an artificial neural network (ANN) coupled to an expert system, said method comprising the steps of:
recognizing a plurality of production yield patterns;
classifying at least one of said production yield patterns into at least one production yield trend;
weighting said at least one production yield trend;
providing notification to expert system (ES) when at least one of said weighted trends passes a predetermined yield-degrading threshold value; and
executing responses from said expert system (ES) in accordance with said expert systems knowledge base.
